(19) United States
(12) Patent Application Publication
(10) Pub. No.: US 2011/0043844 A1
(43) Pub. Date: Feb. 24, 2011

(54) DOCUMENT MANAGEMENT SYSTEM AND METHOD FOR CONTROLLING THE SAME

(75) Inventor: Fumihiro Fukuoka, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/855,522

(22) Filed: Aug. 12, 2010

(30) Foreign Application Priority Data
Aug. 18, 2009 (JP) 2009-189442

(51) Int. Cl. G06F 3/12

(52) U.S. Cl. 358/1.13

(57) ABSTRACT

A document management apparatus according to the present invention includes a management unit configured to manage a document, a request unit configured to request an image processing apparatus to generate an operational element that instructs execution by a reading unit for replacement of the document, a reception unit configured to receive data generated by the reading unit from the image processing apparatus in response to an operation of the operational element by a user of the image processing apparatus, and a replacement unit configured to execute processing for replacing the document managed by the management unit based on the data received by the reception unit.

### BACKGROUND OF THE INVENTION

1. Field of the Invention

The present invention relates to a document management system including an image processing apparatus and a document management apparatus, in which the document management apparatus manages data generated by the image processing apparatus that performs image reading processing. The present invention further relates to a method for controlling the document management system.

For example, the present invention is applicable to a document management system and an information processing apparatus, which registers an operational element in a digital multifunction peripheral to execute page replacement processing on document data stored in the document management apparatus and easily executes scan transmission and page replacement processing.

2. Description of the Related Art

There are conventional methods for reading a document image of a paper medium with a scanner and storing electronic data of the read document in a general file server or a general database, or in a storage device of a document management system. The data management system, especially the document management system, enables a plurality of users to share stored document data. Further, the document management system is functionally operable to perform full text search, attribute search, and version management processing. Therefore, the document management system is suitable for storing a huge amount of document data and document data including numerous pages.

On the other hand, a digital multifunction peripheral having copy, scanner, and facsimile functions has the capability of immediately transmitting acquired data to a storage apparatus of a document management system via network to store therein.

However, in a case where a user wants to replace only a limited part of the stored document data with another data, the user is required to restart processing for scanning and storing all pages or only a replacement page, and then perform editing processing using an editing software program. Therefore, the entire processing procedure becomes very complicated.

To solve the above-described problem, a conventional method discussed in Japanese Patent Application Laid-Open No. 2007-288482 includes causing a digital multifunction peripheral to acquire stored document data from a shared folder and replacing it with page data newly acquired by the scanning performed again.

More specifically, a user who manipulates on an operation panel of the digital multifunction peripheral selects target document data that is not yet subjected to replacement processing (hereinafter, referred to as “original document data”) and further selects a replacement page. Then, the user determines whether to overwrite the original document data with the replacement page or store replacement completed document data as newly registered data. Through the above-described processing, the page replacement and the operation applied to the original document data can be realized.

However, the above-described conventional technique is dissatisfactory in management of data and operability. For example, users are only allowed to overwrite the original document data or register another document data. Therefore, in a case where a huge amount of document data is handled, each replacement completed document data is not associated with the original document data, and therefore users cannot easily check the relationship between them.

Further, users are required to select a replacement page on the operation panel of the digital multifunction peripheral. Therefore, operations in the replacement processing are very troublesome for the users.

### SUMMARY OF THE INVENTION

The present invention is directed to a document management system and a method for controlling the same, which are capable of executing replacement processing on document data registered in a document management apparatus while enabling users to simply operate an operational element displayed on an image processing apparatus.

According to an aspect of the present invention, a document management system includes an image processing apparatus and a document management apparatus. The image processing apparatus includes a reading unit configured to execute image reading processing, and a generation unit configured to generate an operational element that instructs execution by the reading unit for replacement of a document in response to a request from the document management apparatus. The document management apparatus includes a management unit configured to manage a document, a reception unit configured to receive data generated by the reading unit from the image processing apparatus in response to an operation of the operational element by a user of the image processing apparatus, and a replacement unit configured to execute processing for replacing a document managed by the management unit based on the data received by the reception unit.

According to another aspect of the present invention, an image processing apparatus includes a reading unit configured to execute image reading processing, a generation unit configured to generate an operational element that instructs execution by the reading unit for replacement of a document in response to a request from an external apparatus, an operation display unit configured to display the operational element so that a user can operate the operational element, and a transmission unit configured to cause the reading unit to perform the image reading processing in response to an operation of the operational element by the user on the operation display unit and transmit data generated by the reading unit to the external apparatus, wherein the operational element includes replacement information that instructs a replacement page of the document and the transmission unit is configured to transmit the data and the replacement information.

According to yet another aspect of the present invention, a document management apparatus includes a management unit configured to manage a document, a request unit configured to request an image processing apparatus to generate an operational element that instructs execution by a reading unit for replacement of the document, a reception unit configured to receive data generated by the reading unit from the image processing apparatus in response to an operation of the operational element by a user of the image processing apparatus, and a replacement unit configured to execute processing for replacing the document managed by the management unit based on the data received by the reception unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example configuration of a document management system according to an exemplary embodiment of the present invention.

FIG. 2 is a block diagram illustrating an example of an internal configuration of an information processing apparatus included in the document management system according to an exemplary embodiment of the present invention.

FIG. 3 schematically illustrates an internal configuration of a digital multifunction peripheral included in the document management system according to an exemplary embodiment of the present invention.

FIG. 4 is a block diagram illustrating a functional configuration of a document management apparatus and the digital multifunction peripheral according to an exemplary embodiment of the present invention.

FIG. 5A illustrates an example of a document data list display screen according to an exemplary embodiment of the present invention.

FIG. 5B illustrates an example of a document property display screen according to an exemplary embodiment of the present invention.

FIG. 6 illustrates an example of a replacement reservation screen according to an exemplary embodiment of the present invention.

FIG. 7 illustrates an example of a scan operation button list screen that can be displayed by the digital multifunction peripheral according to an exemplary embodiment of the present invention.

FIG. 8 illustrates an example of aversion information list display screen according to an exemplary embodiment of the present invention.

FIG. 9 illustrates an example of a document property display screen, which displays replacement reservation completed document data, according to an exemplary embodiment of the present invention.

FIG. 10A illustrates an example of a data configuration of a document information table according to an exemplary embodiment of the present invention.

FIG. 10B illustrates an example of a data configuration of a document attribute information table according to an exemplary embodiment of the present invention.

FIG. 11A illustrates an example of operation button data transmitted together with a replacement reservation request according to an exemplary embodiment of the present invention.

FIG. 11B illustrates an example of replacement information transmitted together with a page replacement request according to an exemplary embodiment of the present invention.

FIG. 12 is a flowchart illustrating an example of page replacement reservation processing that can be performed by the document management apparatus according to an exemplary embodiment of the present invention.

FIG. 13 is a flowchart illustrating an example of operation button generation and deletion processing that can be performed by the digital multifunction peripheral according to an exemplary embodiment of the present invention.

FIG. 14 is a flowchart illustrating an example of page replacement processing that can be performed by the document management apparatus according to an exemplary embodiment of the present invention.

FIG. 15 is a flowchart illustrating an example of page replacement cancellation processing that can be performed by the document management apparatus according to an exemplary embodiment of the present invention.

### DESCRIPTION OF THE EMBODIMENTS

Various exemplary embodiments, features, and aspects of the invention will be described in detail below with reference to the drawings.

A system according to the present exemplary embodiment is configured to process document data, such as data generated by an image processing apparatus having the capability of reading an image.

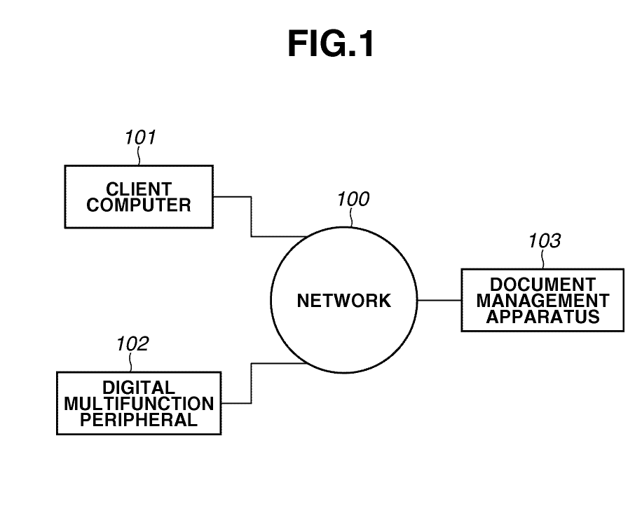

FIG. 1 is a block diagram illustrating an example of a configuration of a document management system. The document management system according to the present invention includes an image forming unit having the capability of reading an image, or includes an image processing apparatus that includes the image forming unit or a comparable information processing apparatus. The document management system according to the present invention further includes a document management unit configured to manage data generated by the image processing apparatus or the information processing apparatus, or includes a document management apparatus that includes the document management unit.

The document management system according to the present exemplary embodiment includes a client computer 101, a digital multifunction peripheral 102 that is operable as the image processing apparatus, and a document management apparatus 103. These apparatuses are mutually connected via a network 100 (e.g., the internet, a local area network (LAN), etc.).

The client computer 101 (i.e., a client device) is, for example, a personal computer that a user can operate. In the following description, the client computer 101 may be referred to as “PC 101”. The PC 101 includes a general web browser (i.e., a software program usable for browsing), which is installed to access a web server.

In a state where the PC 101 by using the web browser is connected to the document management apparatus 103, the PC 101 can send a request to the document management apparatus 103 to perform processing. The document management apparatus 103 performs processing for returning a response (i.e., a processing result) and data to the client computer 101, and further performs processing for transmitting a request to the digital multifunction peripheral 102.

In the present exemplary embodiment, the PC 101 uses the web browser to access the document management apparatus 103. However, the software program usable for browsing is not limited to the web browser. For example, a client application dedicated to the document management apparatus 103 can be installed on the PC 101 beforehand, so that the PC 101 can use the client application to access the document management apparatus 103.

The document management apparatus 103 is a data management apparatus that can manage data generated by the image reading processing. The document management apparatus 103 can manage information relating to data storage place (e.g., a cabinet or a folder), document data, and version, which constitute a hierarchical structure. It is assumed that names of users who are allowed to access, cabinet names, and folder names are registered beforehand in the document management apparatus 103. Further, a general document management system includes a version management function and a page editing function.

A user declares starting an editing operation by checking out shared document data. The user can perform a check-in operation to start exclusive processing on the document data after completing the editing operation. The document management apparatus 103 generates an additional version of the original document data in response to the check-in operation of the user and manages the added document data together with other document data as data belonging to the same document. The document management apparatus 103 according to the present exemplary embodiment includes a version management function applicable to general document management.

The digital multifunction peripheral 102 is an example of the image processing apparatus capable of reading an image. The digital multifunction peripheral 102 is a multifunctional device having copy, scanner, printer, facsimile, and data transmission functions.

The digital multifunction peripheral 102 is connectable to the network 100 and can transmit electronic data (document data etc.), which can be acquired by performing scan processing on a paper document and conversion processing on an document image, to a server (not illustrated) or the document management apparatus 103.

The scan settings and transmission destination information required for execution of the scan processing and the transmission processing can be managed by the digital multifunction peripheral 102, and can be registered beforehand in association with an operation button on the digital multifunction peripheral 102. The transmission destination information includes, for example, network address, URL, folder path, user identification information (e.g., user ID), and authentication information (e.g., password), which are required to access the document management apparatus 103.

Further, it is presumed that document data is already registered in a corresponding folder of the document management apparatus 103 by the operation of the operation button.

The digital multifunction peripheral 102 can execute processing in accordance with a user's operation to realize a designated one of the multiple functions, and can request the document management apparatus 103 to perform processing. The document management apparatus 103 can perform processing for transmitting a response and data, as a processing result, to the digital multifunction peripheral 102. In the following description, the digital multifunction peripheral 102 is described as an example of the image processing apparatus according to the present exemplary embodiment. However, a scanner or any other device that is connectable to the network is employable as an image processing apparatus according to the present exemplary embodiment.

The document management apparatus 103 can be constituted by a single or a plurality of information processing apparatuses. The information processing apparatus has the capability of storing an “information resource including folders and documents” generated and registered by a user into a storage unit and managing the stored information resource.

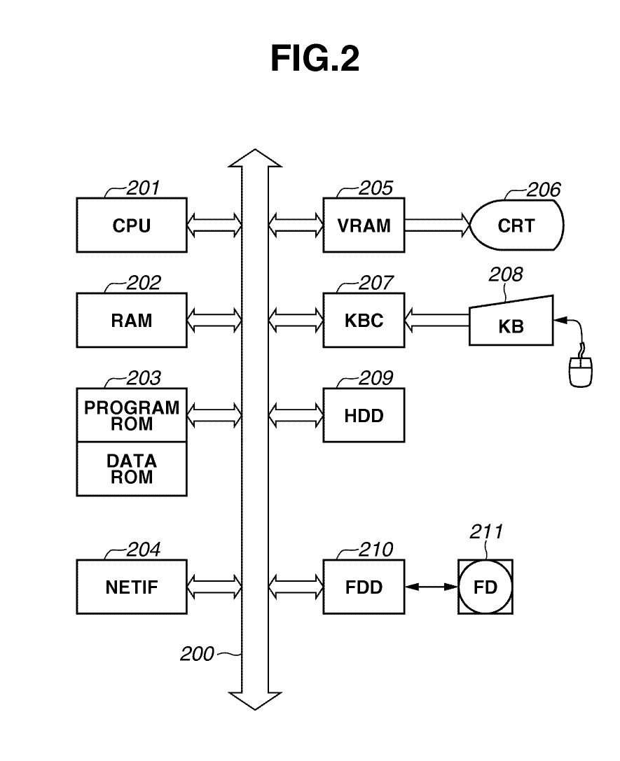

FIG. 2 illustrates an example of an internal configuration of the document management apparatus 103. A central processing unit (CPU) 201 can perform arithmetic processing for the information processing apparatus, and can control operations to be performed by the information processing apparatus. A random access memory (RAM) 202 is functionally operable as a main memory of the CPU 201. The RAM 202 provides a storage area and an execution area for an execution software program, and a data area for the execution software program.

A read only memory (ROM) 203 stores a procedure of operation processing that can be performed by the CPU 201. The ROM 203 includes a program ROM and a data ROM. The program ROM stores a basic software program (OS), which is a system software program required to perform a device control for the information processing apparatus. The data ROM stores information required for the operation of the system. The ROM 203 can be omitted if a hard disk drive (the HDD 209) has a comparable function.

A network interface (NETIF) 204 can control data transfer processing performed via the network 100 between the document management apparatus 103 and an external apparatus, and can diagnose the state of connection between the document management apparatus 103 and the network 100. A video RAM (VRAM) 205 can be used in rasterizing processing of image data to be displayed on a screen of a display device 206 (e.g., a cathode ray tube (CRT) in the present exemplary embodiment), and to perform an image display control based on the rasterized image data.

The display device 206 displays an operational state of the information processing apparatus and images. A keyboard controller (KBC) 207 can control signals input via an external input device (KB) 208. For example, the external input device 208 includes a keyboard and a pointing device (e.g., a mouse), which enable users to perform various operations.

A hard disk drive (HDD) 209 is a storage device that can store application software programs and various data. The application software programs according to the present exemplary embodiment include software programs that can realize functions of various processing units according to the present exemplary embodiment. An external input/output apparatus (FDD) 210 can be used to perform a control for inputting and outputting data from and to various recording media. For example, the FDD 210 reads the above-described application software programs from a recording medium.

A removable media (FD) 211 is a data recording medium that can store data that can be read by the external input/output apparatus 210, and is attachable to or detachable from the apparatus. The removable media 211 is, for example, a magnetic recording medium (e.g., a flexible disk), an optical recording medium (e.g., a compact disc-ROM (CD-ROM)), a magneto-optic recording medium (e.g., a magneto-optical (MO) disk), or a semiconductor recording medium (e.g., a memory card). Further, instead of storing application software programs and data in the HDD 209, the external input/output apparatus (FDD) 210 can read application software programs and data from the removable media (FD) 211.

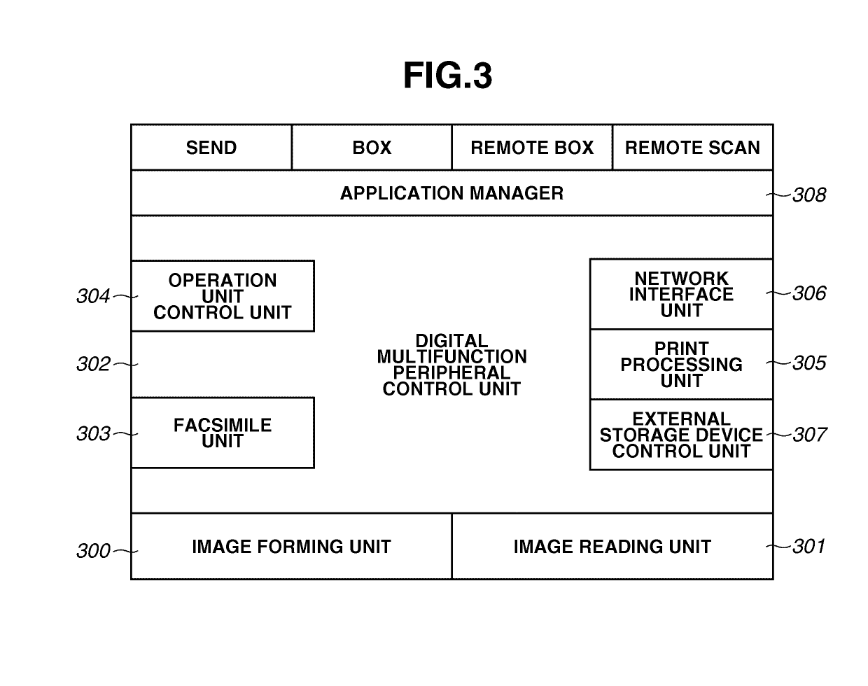

FIG. 3 schematically illustrates a hierarchical configuration of the digital multifunction peripheral 102 according to the present exemplary embodiment. An upper layer illustrated in FIG. 3 is composed of various modules that can realize functions of various applications, such as “Send” relating to a transmission function and “Box” relating to data storage processing. A lower layer is composed of physical apparatuses.

An image forming unit 300 can perform handling of paper sheets, and can execute sequential image forming processes including transfer and fixing of images. Through these processes, the image forming unit 300 can form an image on a recording medium (e.g., a recording paper). For example, the image forming unit 300 includes an inkjet printer and an electro-photographic image forming device.

The image reading unit 301 includes a scanner or a comparable optical information acquisition unit, which can optically read a document image and acquire digital image information. The acquired digital image information can be output to the image forming unit 300. The image forming unit 300 performs image forming processing based on the received image information. The acquired digital image information can be also sent to a facsimile unit 303 or to a network interface unit 306, which can transmit the received digital image information to an external apparatus via a communication line.

A digital multifunction peripheral control unit 302 can control operations to be performed by the image forming unit 300 and the image reading unit 301. For example, the digital multifunction peripheral control unit 302 controls the image forming unit 300 to perform a copying operation based on document information read by the image reading unit 301. Further, the digital multifunction peripheral control unit 302 can control transmission/reception of information to be performed between the network interface unit 306, a print processing unit 305, the facsimile unit 303, and an operation unit control unit 304.

The facsimile unit 303 can execute processing for transmitting and receiving facsimile image data. For example, the facsimile unit 303 transmits digital image information read by the image reading unit 301 to an external device. The facsimile unit 303 decodes a received facsimile signal to cause the image forming unit 300 to perform a recording operation based on the received facsimile information.

The operation unit control unit 304 can generate a signal corresponding to an operational instruction input by a user, which can be performed using an operation panel of an operation unit. The operation unit control unit 304 can control the operation unit to display various data and messages on its display unit.

The print processing unit 305, for example, processes print data input via the network interface unit 306, and outputs the processed print data to the image forming unit 300. The print processing unit 305 controls print processing performed by the image forming unit 300. The network interface unit 306 can control transmission/reception of data performed between the digital multifunction peripheral 102 and other communication terminal via a communication line.

An external storage device control unit 307 can convert image data read by the image reading unit 301 into a data format that is storable in an external storage device. Further, the external storage device control unit 307 performs a control for storing the converted image data into the external storage device. Further, the external storage device control unit 307 performs processing for reading stored data from the external storage device and causing the image forming unit 300 to perform print processing based on the readout data or causing the network interface unit 306 to transmit the data to an external apparatus via the network.

An application manager 308 can manage applications that can be used for copy and scan processing. The application manager 308 receives instructions with respect to activation, termination, installation, and uninstallation of each application or device information generated by the digital multifunction peripheral control unit 302. The application manager 308 controls each application based on the received instruction or information.

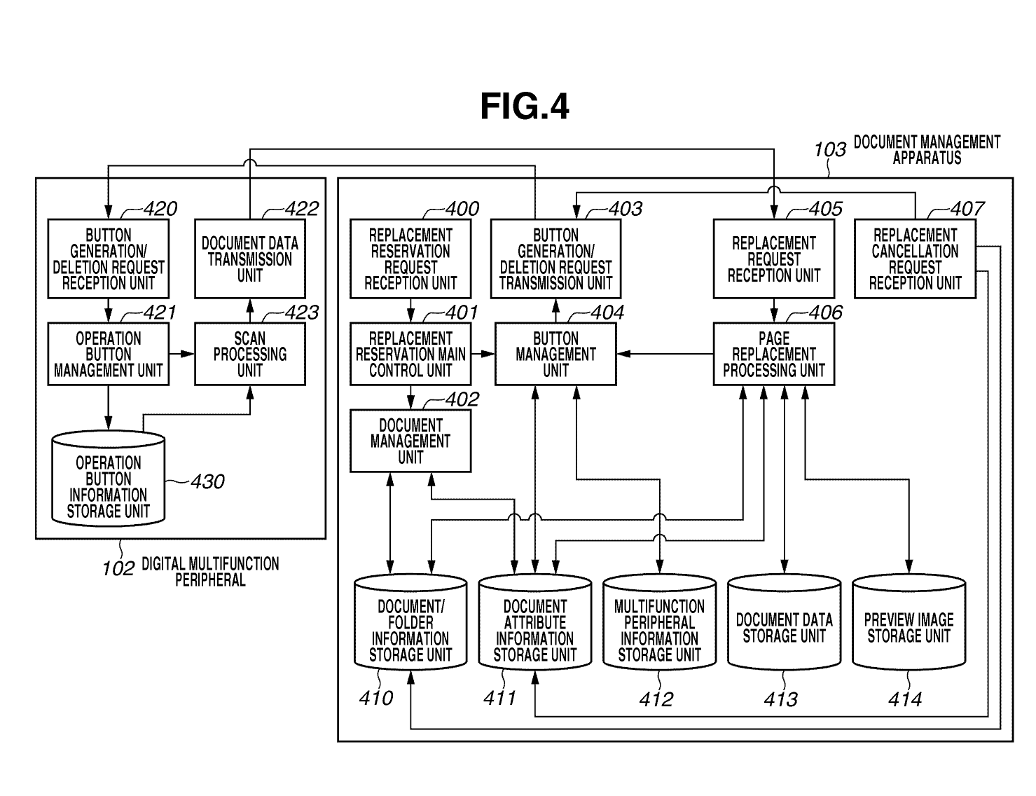

FIG. 4 is a block diagram illustrating an example of a functional configuration of the digital multifunction peripheral 102 and the document management apparatus 103. As illustrated in FIG. 4, the digital multifunction peripheral 102 and the document management apparatus 103 include various units that are functionally operable. FIG. 4 illustrates a configuration of a single apparatus that includes functionally operable units provided therein.

However, a plurality of information processing apparatuses can be used to cooperatively constitute the functionally operable units of the document management apparatus 103 illustrated in FIG. 4. Further, the digital multifunction peripheral 102 and the document management apparatus 103 may include other processing units and information storage units although they are not directly related to the present invention. Thus, description of these units is omitted.

The document management apparatus 103 includes a plurality of processing units 400 to 407 and information storage units 410 to 414. Each of the processing units 400 to 407 can execute processing in response to a request received from the PC 101 or the digital multifunction peripheral 102. Further, the processing units 400 to 407 can read and write information from and to the information storage units 410 to 414.

The digital multifunction peripheral 102 includes a plurality of processing units 420 to 423 and an operation button information storage unit 430. Each of the processing units 420 to 423 can execute processing in response to a user's operation or a request received from the document management apparatus 103. Further, the processing units 420 to 423 can read and write information from and to the information storage unit (i.e., the operation button information storage unit 430 in the present exemplary embodiment).

Functions and roles of respective units illustrated in FIG. 4 are described below in more detail with reference to example screens and flowcharts.

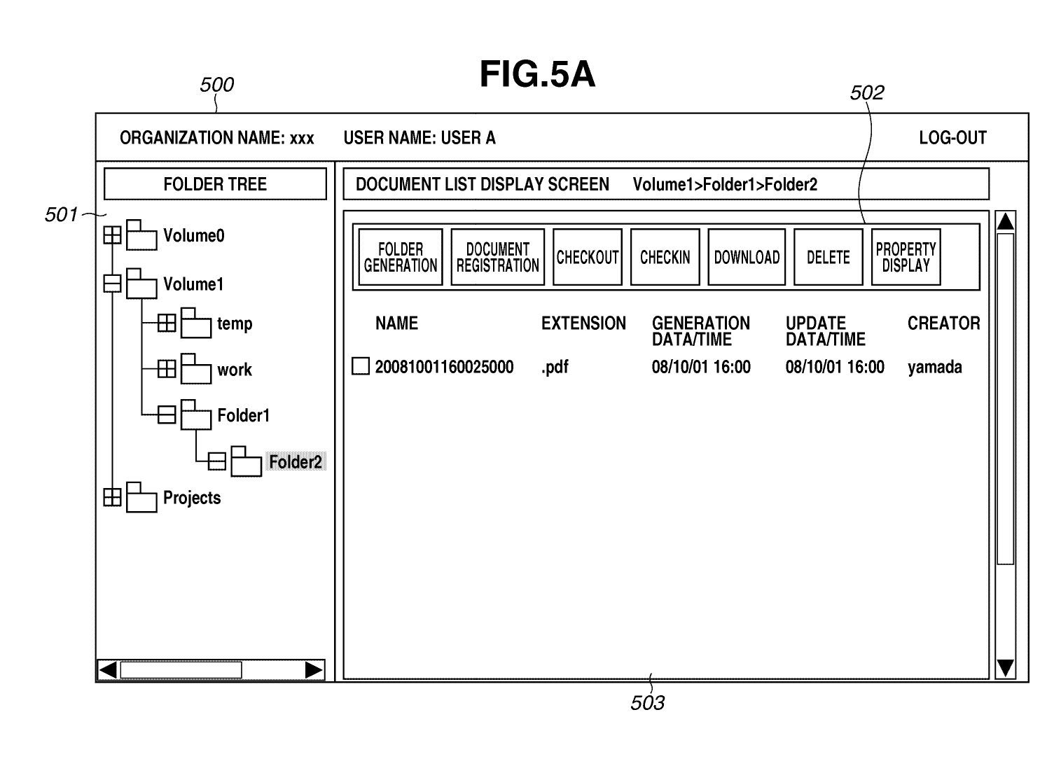

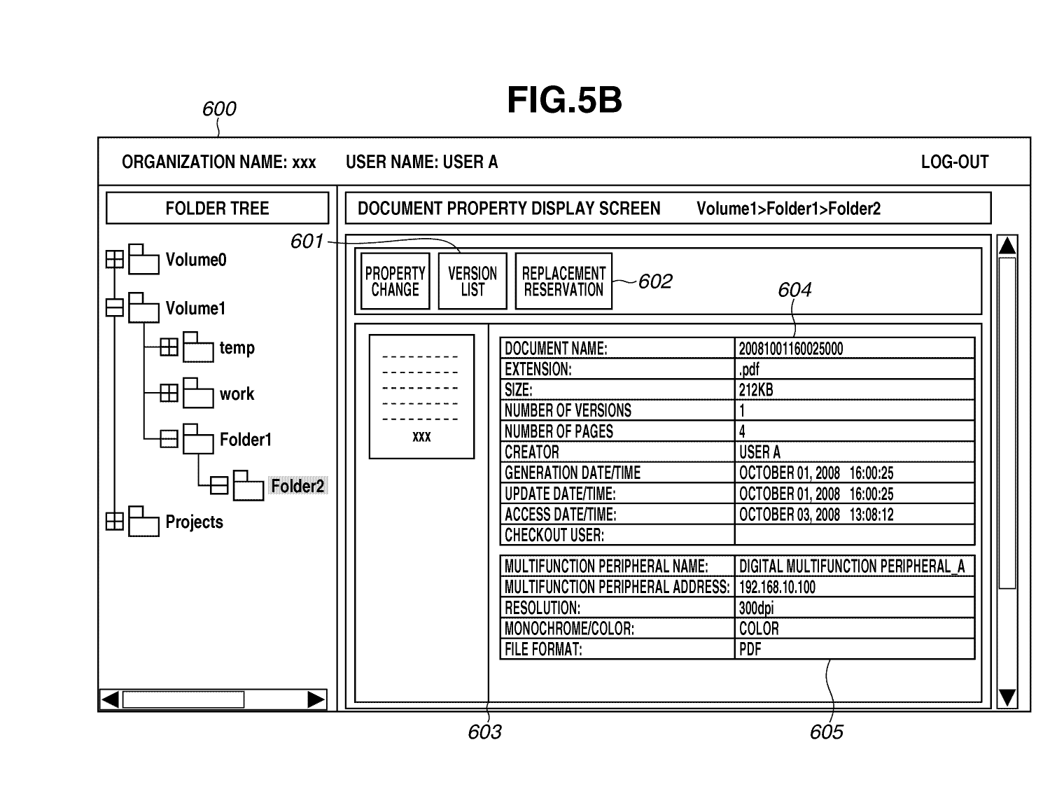

FIGS. 5A, 5B, 6, and 7 illustrate examples of user interfaces that can be displayed by the document management apparatus 103 and the digital multifunction peripheral 102. The user interfaces according to the present exemplary embodiment are not limited to the examples illustrated in FIGS. 5A to 7 in format, configuration, and operational element. Therefore, any other user interfaces capable of realizing the required functions are employable.

FIG. 5A illustrates an example of a document data list display screen, which is a main screen of the user interface provided for an application that accesses the information resource of the document management apparatus 103. A display screen 500 includes a folder tree display field 501 positioned on the left side thereof and a document list display screen field positioned on the right side thereof. The folder tree display field 501 displays a hierarchical structure of folders and enables users to designate an operation to be performed. The document list display screen field includes an operation button field 502 and an information display field 503. The information displayed in the information display field 503 includes a list of data in a selected folder.

The operation button field 502 displays a button group composed of a plurality of operation buttons, which enable users to execute various processing with respect to the folders displayed as a list and document data. The operation button group is constituted by a plurality of button objects that are differentiated according to the information to be displayed.

A hyperlink is attached to a button image or an icon image or to a text in the user interface. If a user clicks a button image, an icon image, or a text with a mouse, the web browser of the PC 101 transmits a processing request to the document management apparatus 103. When the user performs an operation, the user can request processing to be performed on a folder or document data via the user interface.

According to the example illustrated in FIG. 5A, the folder path of a selected folder is “Volume1>Folder1>Folder2” and the selected folder includes document data named “20081001160025000”. This document data represents a result of scan and transmission processing performed by the digital multifunction peripheral 102, which is stored in the above-described folder.

Various buttons indicating folder generation, document registration, checkout, checkin, download, deletion, and property display are disposed in the operation button field 502. If document data “20081001160025000” is selected and the property display button in the operation button field 502 is operated by a user, the document management apparatus 103 executes screen transition processing, and displays a screen 600 illustrated in FIG. 5B.

FIG. 5B illustrates an example of a document property display screen that displays attribute information of document data. The screen 600 includes a folder tree display field positioned on the left side thereof and a document property display screen field positioned on the right side thereof. The document property display screen field includes an operation button field and a document property information display field 603. A property change button, a version list button 601, and a replacement reservation button 602 are disposed in the operation button field.

The document property information display field 603 displays detailed attribute information of document data together with thumbnail images. In a case where a user wants to make a reservation for page replacement of the document data, the user can operate the replacement reservation button 602 displayed on the screen illustrated in FIG. 5B.

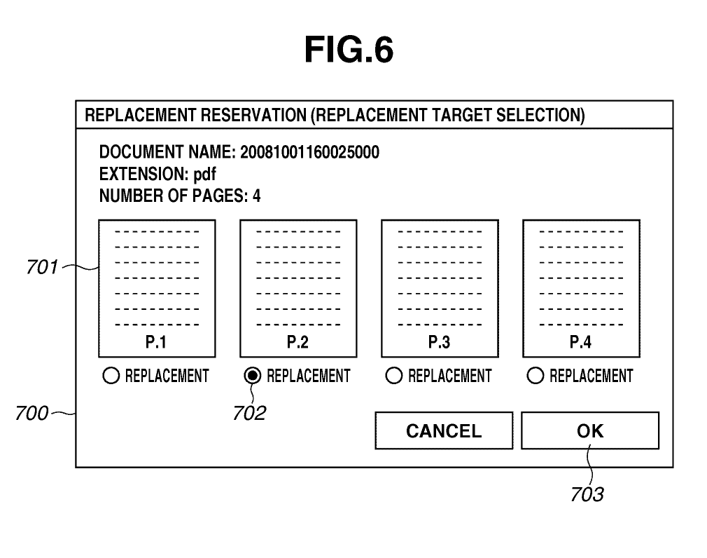

If the document management apparatus 103 receives a request that is transmitted in response to execution of the replacement reservation button 602 by the user, the document management apparatus 103 executes the screen transition processing and displays a screen illustrated in FIG. 6.

FIG. 6 illustrates an example of the replacement reservation screen, which enables users to select a page as a replacement target of the document data. A replacement reservation screen 700 illustrated in FIG. 6 includes a preview image display field 701 of each page, a replacement page designation button 702 attached to each preview image display field 701, and a processing execution button 703. The preview image display field 701 displays a preview image of each page with respect to the document data designated on the document property display screen 600.

In the present exemplary embodiment, the replacement page designation button 702 is disposed beneath each preview image so that a replacement target can be selected by operating the replacement page designation button 702. If a user selects a page to be replaced and operates the corresponding processing execution button 703, the PC 101 transmits a replacement reservation request to the document management apparatus 103.

In the document management apparatus 103, a replacement reservation request reception unit 400 (see FIG. 4) receives the replacement reservation request, and sends the received data together with the replacement reservation request to a replacement reservation main control unit 401. The replacement reservation main control unit 401 sends target document data together with its identifier and page information of a replacement target to a document management unit 402 and a button management unit 404.

The document management unit 402 has a state management function for managing the state of document data. To confirm the state of document data selected by a user, the document management unit 402 can perform reading processing using the identifier of the received document data to acquire information relating to the document data from a document/folder information storage unit 410 and a document attribute information storage unit 411.

The document management unit 402 determines whether replacement reservation of the document data is feasible based on the acquired information. If it is determined that the replacement reservation of the document data is feasible, the document management unit 402 changes the state of the document data to a checkout state and a replacement reservation state.

The button management unit 404 performs reading processing using the identifier of the received document data to acquire required information from each storage unit. More specifically, the button management unit 404 reads document attribute information from the document attribute information storage unit 411. Further, the button management unit 404 can read multifunction peripheral information from a multifunction peripheral information storage unit 412. The multifunction peripheral information includes scan settings and information indicating a digital multifunction peripheral that has executed scanning of the document data.

Next, the button management unit 404 generates information required for a button generation request based on attribute information of read document data, scan setting information, and multifunction peripheral information, and transmits the generated information to a button generation/deletion request transmission unit 403.

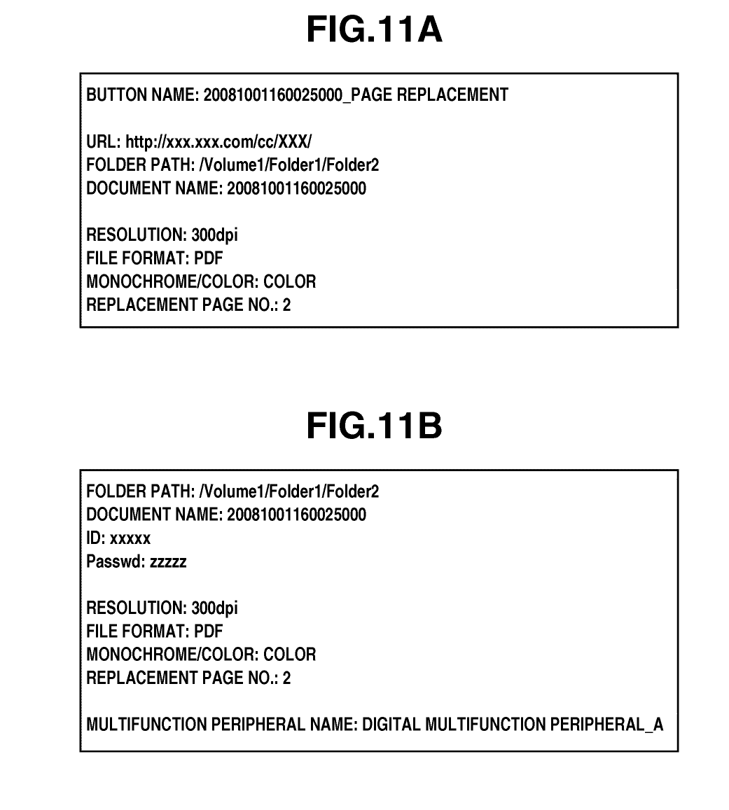

The button generation/deletion request transmission unit 403 transmits the information required for the button generation request together with button information to the digital multifunction peripheral 102. FIG. 11A illustrates an example of the data transmitted together with the button generation request.

The data illustrated in FIG. 11A includes button name, address information (URL), folder path, document name, resolution, file format, monochrome/color, and replacement page number, which are information required for execution of scan transmission and button generation. To realize the present invention, a data configuration different from that illustrated in FIG. 11A may be used.

In the digital multifunction peripheral 102, the button generation/deletion request reception unit 420 receives the button generation request and sends the request together with the received button information to the operation button management unit 421. The operation button management unit 421 executes button generation processing based on the received button information, and stores generated data into the operation button information storage unit 430.

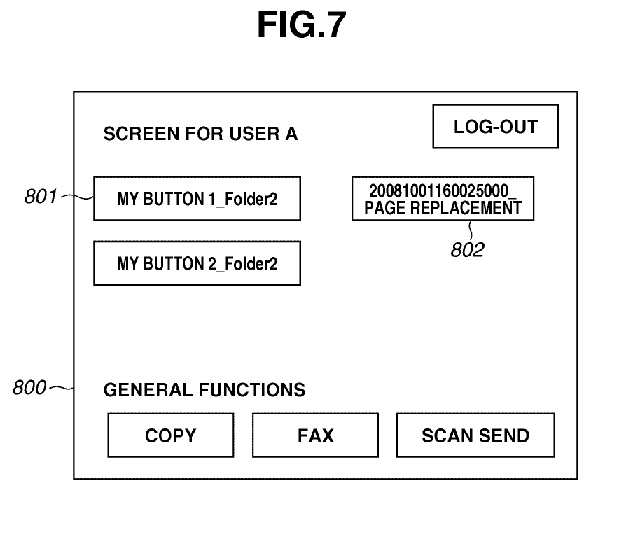

FIG. 7 illustrates an example of a user interface screen that can be displayed on the operation unit of the digital multifunction peripheral 102. The screen illustrated in FIG. 7 includes a list of scan operation buttons that serve as operational elements.

In the present exemplary embodiment, the list of scan operation buttons is managed for each user and can be displayed in response to a log-in operation of the digital multifunction peripheral 102. The example illustrated in FIG. 7 is a screen dedicated to user A. In FIG. 7, an operation button 801 is an operational element that is displayed for storage to a predetermined folder of the document management apparatus 103. An operation button 802 is an operational element that is displayed for page replacement of specific document data generated in response to a request from the document management apparatus 103.

The operation button 802 is an operation button that is generated and displayed as a result responding to the button generation request transmitted by the execution of the replacement reservation illustrated in FIG. 6. The operational element is not limited to the above-described button and can be replaced with any other object that is appropriate for operation.

If a user sets a paper document on the image reading unit 301 (see FIG. 3) of the digital multifunction peripheral 102 and operates the operation button 801 illustrated in FIG. 7, the image reading unit 301 executes processing for reading the paper document. The scan processing unit 423 illustrated in FIG. 4 reads scan setting information that is set for the operation button 801 and transmission destination setting information from the operation button information storage unit 430. The scan processing unit 423 generates document data according to the acquired setting information, and sends the generated document data to the document data transmission unit 422.

The document data transmission unit 422 transmits the document data and storage destination information to the document management apparatus 103 according to the transmission destination setting information. Although not illustrated in the drawings, the document management apparatus 103 performs processing for storing the received document data into a predetermined folder via a designated path based on the storage destination information.

If the user operates the operation button 802 illustrated in FIG. 7 in a state where a page of the paper document to be replaced is set on the image reading unit 301 (see FIG. 3) of the digital multifunction peripheral 102, the image reading unit 301 executes processing for reading the page to be replaced. The scan processing unit 423 illustrated in FIG. 4 reads the scan setting information and the transmission destination setting information, which are set for the operation button 802, from the operation button information storage unit 430. The, the scan processing unit 423 generates document data according to the settings, and sends the generated document data to the document data transmission unit 422.

The document data transmission unit 422 transmits a page replacement request to the document management apparatus 103 according to the transmission destination setting. A replacement request reception unit 405 of the document management apparatus 103 receives the page replacement request from the digital multifunction peripheral 102. The replacement request reception unit 405 sends document data of a replacement page together with replacement information to a page replacement processing unit 406.

FIG. 11B illustrates an example of the replacement information received together with the replacement request, which includes items of folder path, document name, user ID, password, resolution, file format, monochrome/color, replacement page number, and multifunction peripheral name. These data are required to execute page replacement, storage of replacement completed document data, and checkin processing. The replacement information according to the present exemplary embodiment is not limited to the example illustrated in FIG. 11B. Therefore, the data configuration of the replacement information can be differentiated from that of FIG. 11B.

The page replacement processing unit 406 reads document attribute information from the document/folder information storage unit 410 and the document attribute information storage unit 411. Further, the page replacement processing unit 406 reads document data from a document data storage unit 413.

Then, the page replacement processing unit 406 executes processing for replacing the data of a designation page of the document data with the document data of the replacement page. Subsequently, the page replacement processing unit 406 stores the document data generated by the replacement processing into the document data storage unit 413. Next, the page replacement processing unit 406 updates the data stored in the document/folder information storage unit 410 and the document attribute information storage unit 411, and further updates the document data to a checkin state.

The page replacement processing unit 406 performs processing for generating a preview image relating to the document data based on the page replacement completed document data stored in the document data storage unit 413. The page replacement processing unit 406 stores the generated preview image data into a preview image storage unit 414.

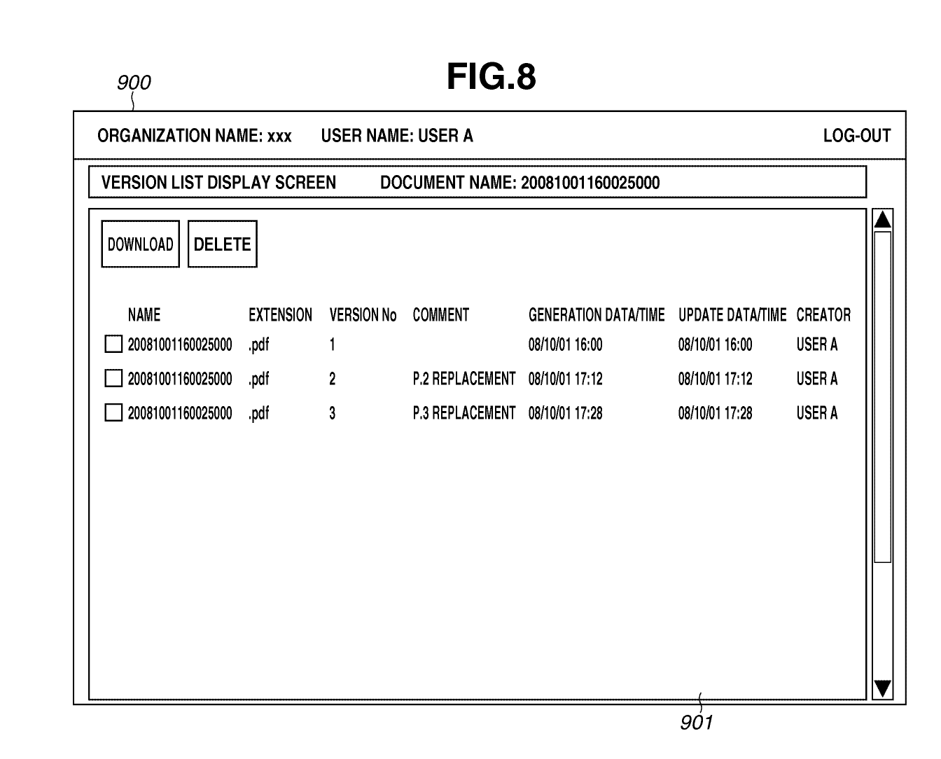

FIG. 8 illustrates an example of a version information list display screen, which displays a list of version information with respect to document data. The screen illustrated in FIG. 8 can be displayed when the version list button 601 is operated on the document property display screen illustrated in FIG. 5B.

The version list screen includes an operation button field and an information display field 901. A deletion button and a download button are provided in the operation button field. If a user selects a desired version of the document data displayed in the information display field 901, and operates the deletion button or the download button, the selected version of the document data can be deleted or downloaded. The download and deletion functions are not related to the present invention and, are not described below in detail.

The version information displayed in the information display field 901 illustrated in FIG. 8 includes document data of a version number 1 that indicates the original document data. The version information further includes document data of a version number 2 and document data of a version number 3 that are checked-in data having resulted through the page replacement processing.

The version information according to the present exemplary embodiment includes comment data as an attribute of the document data, which is stored in a predetermined storage unit to explicitly indicate the content of the page replacement having been executed.

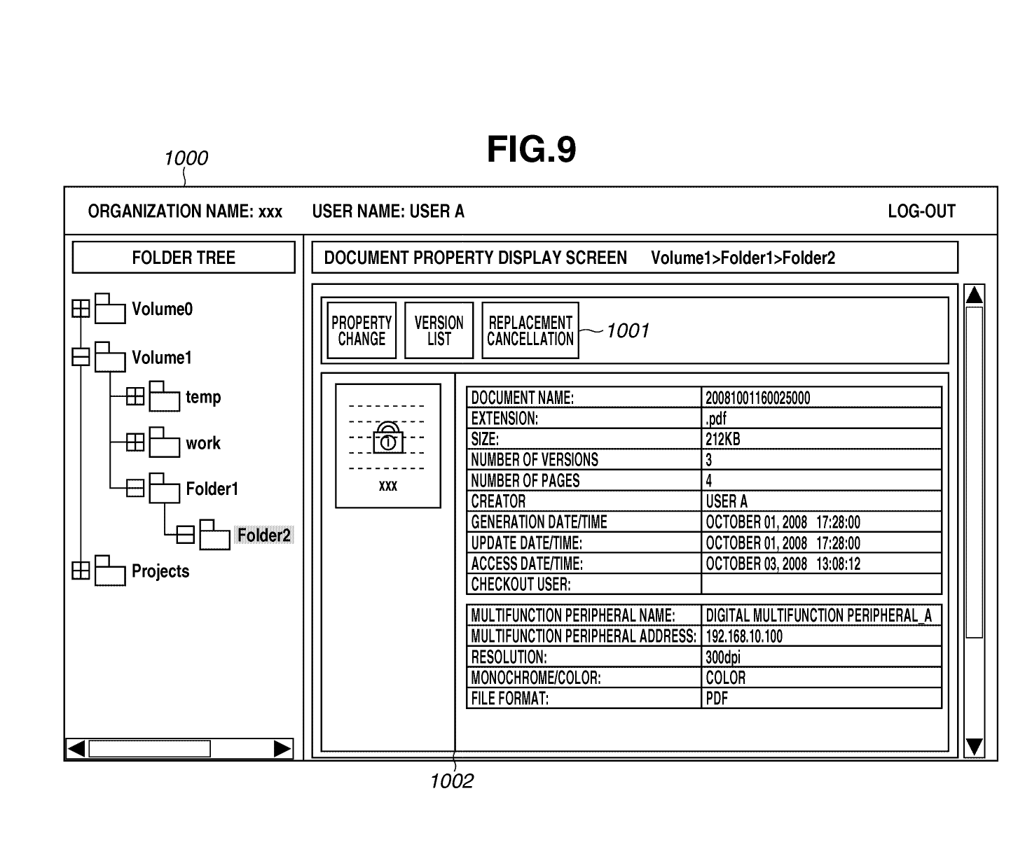

FIG. 9 illustrates an example of the document property display screen, which displays attribute information of document data, similar to the screen illustrated in FIG. 5B. A screen 1000 illustrated in FIG. 9 can be displayed when the properties of the document data is displayed again after the page replacement reservation is made on the screen illustrated in FIG. 5B.

The document property display screen illustrated in FIG. 9 is different from the screen illustrated in FIG. 5B in that a replacement cancellation button 1001 is provided instead of the replacement reservation button 602 and an icon indicating that the page replacement processing is currently in progress is displayed in an information display field 1002. Alternatively, a text indicating that the page replacement processing is currently in progress can be displayed.

If the user operates the replacement cancellation button 1001 on the screen 1000 to cancel the page replacement processing that is currently executed for the document data, a page replacement cancellation request is transmitted to the document management apparatus 103. A replacement cancellation request reception unit 407 (see FIG. 4) of the document management apparatus 103 receives the replacement cancellation request. The replacement cancellation request reception unit 407 updates information relating to the document/folder information storage unit 410 and information relating to the document attribute information storage unit 411 according to the replacement cancellation request. The replacement cancellation request reception unit 407 cancels the checkout state and also cancels the page replacement reservation state.

Further, the replacement cancellation request reception unit 407 sends a replacement cancellation notification to the button generation/deletion request transmission unit 403. The button generation/deletion request transmission unit 403 transmits a button deletion request together with button information to the digital multifunction peripheral 102.

In the digital multifunction peripheral 102, the button generation/deletion request reception unit 420 receives the button deletion request and sends the button information received together with the button deletion request to the operation button management unit 421. The operation button management unit 421 executes processing for deleting a corresponding operation button, which is stored in the operation button information storage unit 430, with reference to the button information that is usable as a search key.

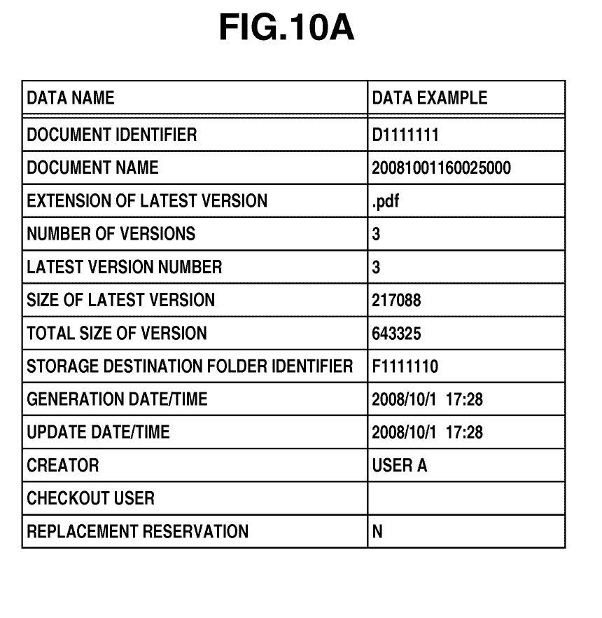

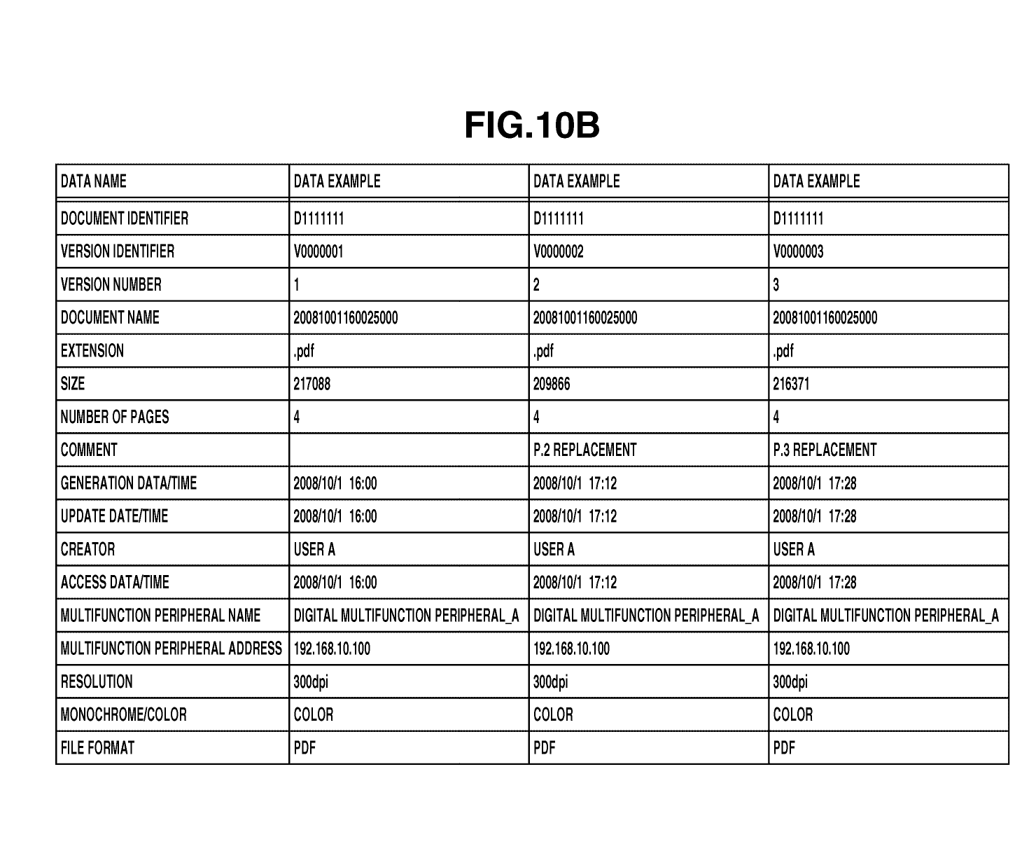

FIG. 10A illustrates an example of a data configuration of document information according to the present exemplary embodiment. FIG. 10B illustrates an example of a data configuration of document attribute information. In FIGS. 10A and 10B, data names and data examples are written in a table format. These data correspond to information relating to the document data displayed on the document list display screen illustrated in FIG. 5A, the document property display screen illustrated in FIG. 5B, and the version information list display screen illustrated in FIG. 8.

The illustrated data according to the present exemplary embodiment as minimum required information includes various names, identifier, extension, version number, version size, date and time, and multifunction peripheral information. Any other data configuration can be used to express document information according to the present exemplary embodiment.

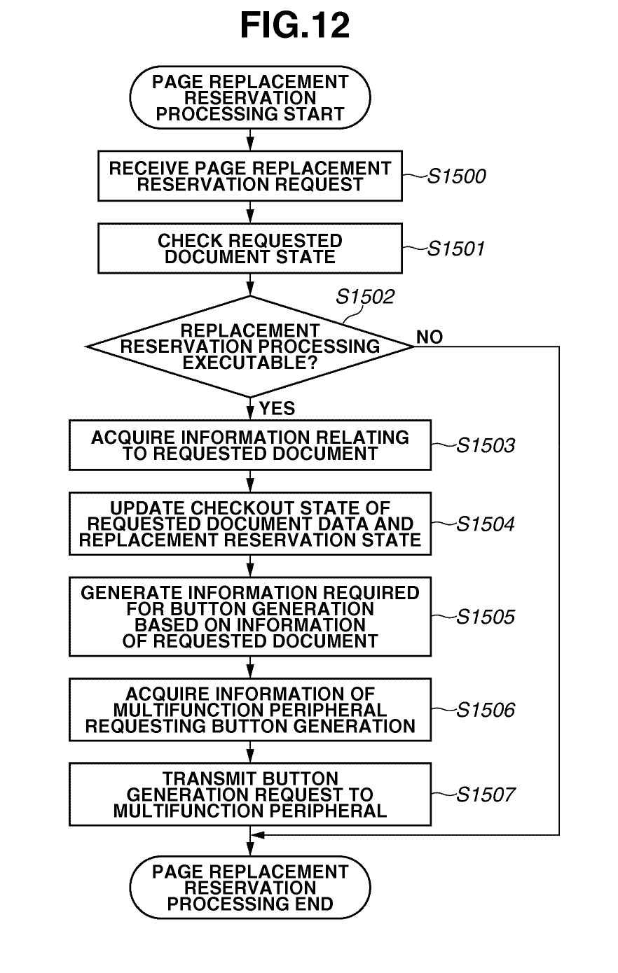

Example processing that can be performed by the document management system according to the present exemplary embodiment is described below with reference to FIGS. 12 to 15.

A user performs the screen operations described with reference to FIGS. 5 to 7 to instruct the document management apparatus 103, via the web browser of the PC 101, to send a page replacement reservation request relating to the document data stored in the document management apparatus 103. The document management apparatus 103 receives the page replacement reservation request from the PC 101 and transmits a page replacement button generation request to the digital multifunction peripheral 102.

It is assumed that the log-in operation of the document management apparatus 103 and selection of replacement target document data on the document data list display screen illustrated in FIG. 5A are already completed by the user before performing the operations on respective screens illustrated in FIGS. 5 to 7. Accordingly, identifiers relating to the user and selected document data are already stored in the RAM 202 of the document management apparatus 103.

An example of page replacement reservation processing is described below. FIG. 12 is a flowchart illustrating an example procedure of processing that can be performed by the document management apparatus 103 to transmit the page replacement button generation request to the digital multifunction peripheral 102 in response to the page replacement reservation request.

In step S1500, the replacement reservation request reception unit 400 of the document management apparatus 103 receives the replacement reservation request together with a page number of a replacement target page and performs processing for rasterizing the page number in the RAM 202. The replacement reservation main control unit 401, then, takes over the processing of the flowchart illustrated in FIG. 12.

In step S1501, the replacement reservation main control unit 401 performs reading processing using the identifier of the document data stored in the RAM 202 to acquire information relating to the document data from the document/folder information storage unit 410. Then, the replacement reservation main control unit 401 performs processing for rasterizing the acquired information in the RAM 202.

In step S1502, the replacement reservation main control unit 401 checks the state of document data that serves as a replacement reservation target of the above-described document data. If it is determined that the target document data is in a replacement reservation executable state (YES in step S1502), the processing proceeds to step S1503. On the other hand, if it is determined that the target document data is not in the replacement reservation executable state (NO in step S1502), the replacement reservation main control unit 401 terminates the page replacement reservation processing illustrated in FIG. 12. For example, the replacement reservation is not executable in a case where the right to perform editing on the document data is not preserved for a log-in user any more or in a case where checkout processing is performed by other user.

In step S1503, the replacement reservation main control unit 401 performs reading processing using the identifier of the document data stored in the RAM 202 to acquire information relating to the document data from the document/folder information storage unit 410 and the document attribute information storage unit 411. Then, the replacement reservation main control unit 401 performs processing for rasterizing the acquired information in the RAM 202.

Next, in step S1504, the replacement reservation main control unit 401 updates the data stored in the document/folder information storage unit 410, which represents the checkout state and the replacement reservation state relating to the document data. The button management unit 404, then, takes over the processing of the flowchart illustrated in FIG. 12 from the replacement reservation main control unit 401.

In step S1505, the button management unit 404 performs reading processing using the information relating to the document data stored in the RAM 202 to acquire storage destination folder information and scan setting information that are required for button generation. Next, in step S1506, the button management unit 404 performs reading processing using the information relating to the document data to acquire information identifying a multifunction peripheral from the multifunction peripheral information storage unit 412. Then, the button management unit 404 stores the acquired information into the RAM 202.

The button management unit 404 executes processing for generating operation button data to be transmitted to the digital multifunction peripheral 102 based on the document data information, the scan setting information, and the multifunction peripheral information. The button management unit 404 stores the generated operation button data into the RAM 202. The operation button data is data relating to generation of the operation button (see the operation button 802 illustrated in FIG. 7) and behavior in the operation.

In step S1507, the button generation/deletion request transmission unit 403 reads the operation button data from the RAM 202 and transmits the button generation request together with the operation button data to the button generation/deletion request reception unit 420 of the digital multifunction peripheral 102.

Through the above-described processing, the document management apparatus 103 can accomplish the processing for changing the state of document data that the user designated as a replacement target. Further, the document management apparatus 103 can accomplish operation button data generation and button generation request transmission processing to transmit the button generation request to the digital multifunction peripheral.

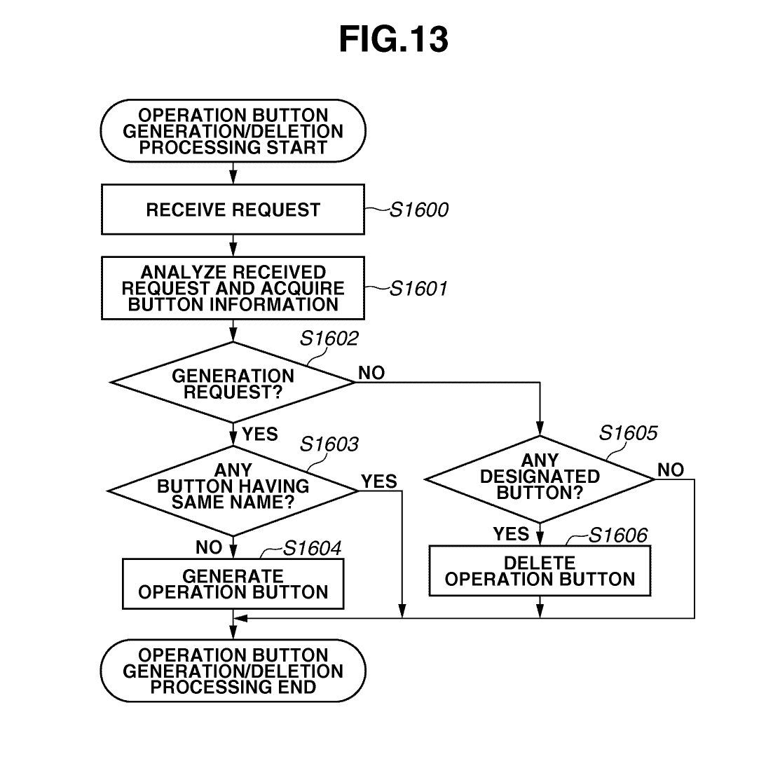

Next, an example of operation button generation and deletion processing is described. FIG. 13 is a flowchart illustrating an example procedure of processing that can be performed by the digital multifunction peripheral 102 in response to a button generation/deletion request received from the document management apparatus 103.

First, in step S1600, the button generation/deletion request reception unit 420 receives a button generation request or a deletion request from the document management apparatus 103. Next, in step S1601, the button generation/deletion request reception unit 420 acquires operation button data received together with the request.

In step S1602, the button generation/deletion request reception unit 420 determines whether the received request is the button generation request or the deletion request. If it is determined that the received request is the button generation request (YES in step S1602), the processing proceeds to step S1603. If it is determined that the received request is the deletion request (NO in step S1602), the processing proceeds to step S1605.

In step S1603, the operation button management unit 421 takes over the processing of the flowchart illustrated in FIG. 13. The operation button management unit 421 analyzes the operation button data and determines whether an operation button having the same name is already present. If it is determined that the operation button having the same name is present (YES in step S1603), the operation button management unit 421 terminates the operation button generation and deletion processing illustrated in FIG. 13. On the other hand, if it is determined that the operation button having the same name is not present (No in step S1603), the processing proceeds to step S1604.

In step S1604, the operation button management unit 421 stores operation button information generated based on the operation button data into the operation button information storage unit 430. Through the above-described processing, the digital multifunction peripheral 102 can accomplish the preparation for the generation of the operation button 802, which is required in executing scan transmission to the document management apparatus 103.

More specifically, in a case where the screen display illustrated in FIG. 7 is performed, the operation button 802 generated based on the data stored in the operation button information storage unit 430 can be displayed as an operable button in the display field. Thus, the digital multifunction peripheral 102 terminates the operation button generation processing.

If it is determined that the received request is the deletion request of the operation button (NO in step S1602), then in step S1605, the operation button management unit 421 takes over the processing of the flowchart illustrated in FIG. 13. More specifically, the operation button management unit 421 analyzes the operation button data and determines whether the operation button designated as a deletion target is present. If it is determined that the target operation button is not present (NO in step S1605), the operation button management unit 421 terminates the operation button generation and deletion processing illustrated in FIG. 13.

If it is determined that the target operation button is present (YES in step S1605), then in step S1606, the operation button management unit 421 deletes the information relating to the target operation button from the operation button information storage unit 430, and terminates the operation button generation and deletion processing illustrated in FIG. 13.

In the present exemplary embodiment, the operation button registered in the digital multifunction peripheral 102 can be shared by all users who operate the digital multifunction peripheral 102. However, it may also be useful to allow registration of the operation button for each user.

Next, an example of the page replacement processing is described below. As illustrated in FIG. 7, the operation button 802 generated in response to the button generation request from the document management apparatus 103 is displayed on the screen. If a user operates the operation button 802, the digital multifunction peripheral 102 transmits a page replacement request together with document data of a replacement page to the document management apparatus 103.

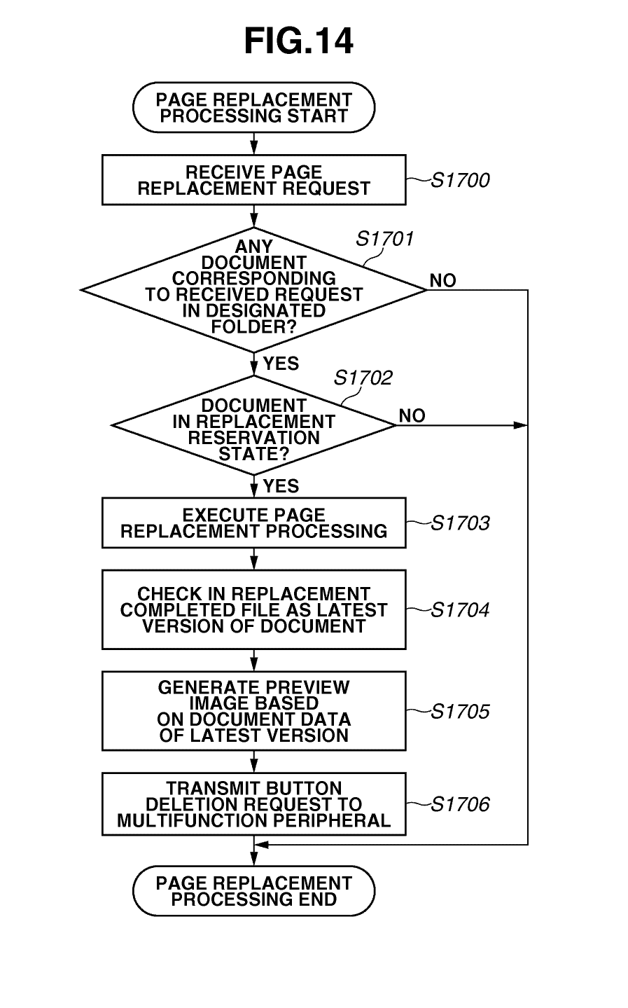

FIG. 14 is a flowchart illustrating an example procedure of the page replacement processing that can be performed by the document management apparatus 103 in response to the page replacement request received from the digital multifunction peripheral 102.

In step S1700, the replacement request reception unit 405 of the document management apparatus 103 stores the document data of the replacement page received together with the page replacement request into a temporary storage area of the HDD 209. Further, the replacement request reception unit 405 stores the replacement information into the RAM 202. The page replacement processing unit 406, then, takes over the processing of the flowchart illustrated in FIG. 14.

In step S1701, the page replacement processing unit 406 extracts information indicating a folder path of a storage destination and a document name from the replacement information stored in the RAM 202. The page replacement processing unit 406 performs reading processing based on the extracted information to acquire information relating to the document data from the document/folder information storage unit 410 and the document attribute information storage unit 411. Then, page replacement processing unit 406 performs processing for rasterizing the read information in the RAM 202.

Then, the page replacement processing unit 406 determines whether document data having the same document name is present in the designated storage destination folder. If it is determined that the requested document data is not present (NO in step S1701), the page replacement processing unit 406 terminates the page replacement processing illustrated in FIG. 14. On the other hand, if it is determined that the requested document data is present (YES in step S1701), the processing proceeds to step S1702.

In step S1702, the page replacement processing unit 406 determines whether the document data is in the replacement reservation state. If it is determined that the document data is not in the replacement reservation state (NO in step S1702), the page replacement processing unit 406 terminates the page replacement processing illustrated in FIG. 14. Further, if it is determined that the document data is in the replacement reservation state (YES in step S1702), the page replacement processing unit 406 determines that replacement of the document data is feasible. Then, the processing proceeds to step S1703.

In step S1703, the page replacement processing unit 406 reads replacement target document data from the document data storage unit 413 and stores the read document data into a temporary storage area of the HDD 209. The page replacement processing unit 406 reads the replacement target document data and the document data of the replacement page, which are stored in the temporary storage area of the HDD 209. Then, the page replacement processing unit 406 executes page replacement processing according to the replacement information and stores replacement completed document data into the document data storage unit 413.

In step S1704, the page replacement processing unit 406 updates the data of the document/folder information storage unit 410 and the document attribute information storage unit 411. The page replacement processing unit 406 further updates the state of the replacement completed document data, as a latest version, into the checkin state.

In step S1705, the page replacement processing unit 406 reads the replacement completed document data (i.e., the document data of the latest version) from the temporary storage area of the HDD 209 and executes preview image generation processing. The page replacement processing unit 406 stores the generated preview image into the preview image storage unit 414.

In step S1706, the button management unit 404 receives a notification from the page replacement processing unit 406 and instructs the button generation/deletion request transmission unit 403 to transmit a page replacement button deletion request to the digital multifunction peripheral 102. Then, the document management apparatus 103 completes the above-described sequential page replacement processing.

Next, an example of page replacement cancellation processing is described below. If a user operates the replacement cancellation button 1001 on the screen illustrated in FIG. 9, the web browser of the PC 101 transmits a replacement processing cancellation request to the document management apparatus 103 to cancel the page replacement processing with respect the document data in the replacement reservation state.

If the document management apparatus 103 receives the replacement processing cancellation request, the document management apparatus 103 executes processing for changing the state of the document data, and transmits the page replacement button deletion request to the digital multifunction peripheral 102.

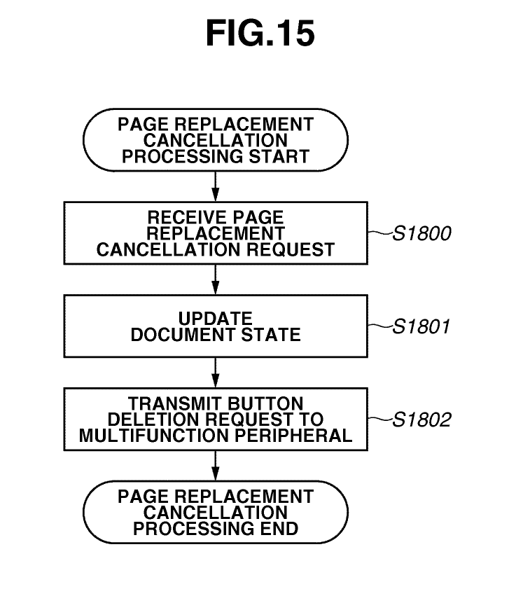

FIG. 15 is a flowchart illustrating an example procedure of processing that can be performed by the document management apparatus 103 to transmit the page replacement button deletion request to the digital multifunction peripheral 102 in response to the received page replacement cancellation request.

In step S1800, the replacement cancellation request reception unit 407 receives the page replacement cancellation request together with cancellation information from the PC 101, and performs processing for rasterizing the cancellation information in the RAM 202. The cancellation information is information required for the page replacement cancellation processing.

In step S1801, the replacement cancellation request reception unit 407 updates the checkout state and the replacement reservation state of the document data in the document/folder information storage unit 410 to the original state, referring to the cancellation information stored in the RAM 202. The button generation/deletion request transmission unit 403 takes over the processing of the flowchart illustrated in FIG. 15. In step S1802, the button generation/deletion request transmission unit 403 transmits the button deletion request to the digital multifunction peripheral 102, and terminates the page replacement cancellation processing illustrated in FIG. 15.

Through the above-described page replacement cancellation processing, the document data in the replacement reservation state can be restored to the ordinary state and the operation button 802 disappears from the digital multifunction peripheral 102.

In the above-described present exemplary embodiment, if the page replacement reservation is made, document data state change processing is performed and the page replacement operation button 802 is generated on the digital multifunction peripheral 102. A user sets only a page to be replaced on the digital multifunction peripheral 102. Then, if the user operates the page replacement operation button to start the processing, document data of only the replacement page is transmitted to the document management apparatus 103.

If the document management apparatus 103 receives the document data of the replacement page, the document management apparatus 103 replaces only a corresponding part of the original document data with the received replacement page and registers the replacement completed document data as a latest version of the original document. Then, the page replacement operation button 802 is deleted upon completing the replacement processing.

As described above, the document management system according to the present exemplary embodiment can flexibly perform page replacement processing for an arbitrary part of document data acquired by scanning processing and registered in a document management apparatus. Further, the document management system according to the present exemplary embodiment can perform version management for document data that is subjected to the replacement processing. Therefore, the present exemplary embodiment brings an effect of simplifying the management of document data.

The page replacement processing performed on only one page is a mere example of the present exemplary embodiment. The document management system according to the present exemplary embodiment can be configured to replace two or more pages of the original document data at a time.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-189442 filed Aug. 18, 2009, which is hereby incorporated by reference herein in its entirety.

What is claimed is:

1. A document management system including an image processing apparatus and a document management apparatus, wherein
the image processing apparatus includes:
a reading unit configured to execute image reading processing; and
a generation unit configured to generate an operational element that instructs execution by the reading unit for replacement of a document in response to a request from the document management apparatus,
wherein
the document management apparatus includes:
a management unit configured to manage a document;
a reception unit configured to receive data generated by the reading unit from the image processing apparatus in response to an operation of the operational element by a user of the image processing apparatus; and
a replacement unit configured to execute processing for replacing a document managed by the management unit based on the data received by the reception unit.

2. The document management system according to claim 1, wherein the operational element includes replacement information that instructs a replacement page of the document managed by the management unit, and the replacement unit is configured to execute the processing for replacing the document managed by the management unit according to the replacement information.

3. An image processing apparatus comprising:
a reading unit configured to execute image reading processing;
a generation unit configured to generate an operational element that instructs execution by the reading unit for replacement of a document in response to a request from an external apparatus;
an operation display unit configured to display the operational element so that a user can operate the operational element; and
a transmission unit configured to cause the reading unit to perform the image reading processing in response to an operation of the operational element by the user on the operation display unit and transmit data generated by the reading unit to the external apparatus,
wherein the operational element includes replacement information that instructs a replacement page of the document, and the transmission unit is configured to transmit the data and the replacement information.

4. A document management apparatus comprising:
a management unit configured to manage a document;
a request unit configured to request an image processing apparatus to generate an operational element that instructs execution by a reading unit for replacement of the document;
a reception unit configured to receive data generated by the reading unit from the image processing apparatus in response to an operation of the operational element by a user of the image processing apparatus; and
a replacement unit configured to execute processing for replacing the document managed by the management unit based on the data received by the reception unit.

5. A method for controlling a document management system including an image processing apparatus and a document management apparatus, wherein
a method for controlling the image processing apparatus includes:
executing image reading processing; and
generating an operational element that instructs execution of the image reading processing for replacement of a document in response to a request from the document management apparatus,
wherein
a method for controlling the document management apparatus includes:
managing a document;
receiving data generated by the image reading processing from the image processing apparatus in response to an operation of the operational element by a user of the image processing apparatus; and
executing processing for replacing a managed document based on the received data.

6. A method for controlling an image processing apparatus, the method comprising:
executing image reading processing;
generating an operational element that instructs execution of the image reading processing for replacement of a document in response to a request from an external apparatus;
displaying the operational element so that a user can operate the operational element; and
performing the image reading processing in response to an operation of the operational element by the user and transmitting data generated by the image reading processing to the external apparatus,
wherein the operational element includes replacement information that instructs a replacement page of the document, and the data is transmitted together with the replacement information.

7. A method for controlling a document management apparatus, the method comprising:
managing a document;
requesting an image processing apparatus to generate an operational element that instructs execution of reading processing for replacement of the document;
receiving data generated by the reading processing from the image processing apparatus in response to an operation of the operational element by a user of the image processing apparatus; and
executing processing for replacing the managed document based on the received data.

8. A non-transitory computer-readable storage medium storing a software program that causes a computer to execute a method for controlling a document management system including an image processing apparatus and a document management apparatus, the method comprising:
causing the image processing apparatus to execute image reading processing;
causing the image processing apparatus to generate an operational element that instructs execution of the image reading processing for replacement of a document in response to a request from the document management apparatus;
causing the document management apparatus to manage a document;
causing the document management apparatus to receive data generated by the image reading processing from the image processing apparatus in response to an operation of the operational element by a user of the image processing apparatus; and
causing the document management apparatus to execute processing for replacing a managed document based on the received data.

9. A non-transitory computer-readable storage medium storing a software program that causes a computer to execute a method for controlling an image processing apparatus, the method comprising:
executing image reading processing;
generating an operational element that instructs execution of the image reading processing for replacement of a document in response to a request from an external apparatus;
displaying the operational element so that a user can operate the operational element; and
performing the image reading processing in response to an operation of the operational element by the user and transmitting data generated by the image reading processing to the external apparatus,
wherein the operational element includes replacement information that instructs a replacement page of the document, and the data is transmitted together with the replacement information.

10. A non-transitory computer-readable storage medium storing a software program that causes a computer to execute a method for controlling a document management apparatus, the method comprising:
managing a document;
requesting an image processing apparatus to generate an operational element that instructs execution of reading processing for replacement of the document;
receiving data generated by the reading processing from the image processing apparatus in response to an operation of the operational element by a user of the image processing apparatus; and
executing processing for replacing the managed document based on the received data.
